(19) United States
(12) Patent Application Publication
(10) Pub. No.: US 2024/0330910 A1
(43) Pub. Date: Oct. 3, 2024

(54) SYSTEMS AND METHODS FOR USE IN ACCOUNT CREDENTIAL CONVERSION

(71) Applicant: MASTERCARD INTERNATIONAL INCORPORATED, PURCHASE, NY (US)

(72) Inventors: Piyush Maurya, Morganville, NJ (US); James Christian Noë, West Wickham (GB); Mark Metcalfe, Hoboken, NJ (US); Jared Ryan Boucher, Curryville, MO (US)

(21) Appl. No.: 18/615,327

(22) Filed: Mar. 25, 2024

Related U.S. Application Data
(60) Provisional application No. 63/455,951, filed on Mar. 30, 2023.

(51) Int. Cl. G06Q 20/38

(52) U.S. Cl. CPC G06Q 20/3821; G06Q 20/3825

(57) ABSTRACT

Systems and methods are provided for converting account credentials in mobile devices. An example method includes receiving a request to digitize a second account in a mobile device, in place of a first account, and determining a type of the second account is different than a type of the first account. The method also includes identifying a first application identifier (AID) for the second account and transmitting, to a digital platform computing device, a request to digitize the second account to the mobile device. The method then further includes receiving, from the digital platform computing device, a notice to digitize the second account to an instance of the application for the second account in the mobile device, where the notice includes an AID for the first account, validating the AID for the first account, and generating and transmitting personalization data to the digital platform computing device.

### CROSS-REFERENCE TO RELATED APPLICATION

This application claims the benefit of, and priority to, U.S. Provisional Application No. 63/455,951, filed Mar. 30, 2023. The entire disclosure of the above application is incorporated herein by reference.

### FIELD

The present disclosure generally relates to systems and methods for use in account credential conversions, in which account credentials are converted, in mobile devices, based on changes in account types associated therewith.

### BACKGROUND

This section provides background information related to the present disclosure which is not necessarily prior art.

Mobile devices are known to include digital applications, such as, for example, wallet applications, etc. in which credentials are provisioned. The credentials, in turn, may be used to initiate transactions, where the credentials are associated with payment accounts, and the payment accounts are used to fund the transactions. The mobile devices may include, for example, smartphones, wearable devices (e.g., smart watches, etc.), or other devices, which are mobile with users. In this way, the mobile devices are used as payment devices. From time to time, based on expiration, the credentials in the mobile devices may be replaced or updated.

### BRIEF DESCRIPTION OF DRAWINGS

The drawings described herein are for illustrative purposes only of selected embodiments and not all possible implementations, and are not intended to limit the scope of the present disclosure:

FIG. 1 illustrates an example system for use in converting account credentials in mobile devices based on changes in account types;

FIG. 2 is a block diagram of an example computing device that may be used in the system of FIG. 1;

FIG. 3 illustrates an example method that may be implemented via the system of FIG. 1 for use in converting account credentials in mobile devices.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Payment accounts may be provisioned to mobile devices, or digital applications therein, by storing credentials in the mobile devices. The credentials then, in turn, may be passed to parties in furtherance of transactions with the parties (or involving the parties). The payment accounts may be changed, from time to time, whereby new types of payment accounts are required. In connection therewith, users of the mobile devices are required to provision new credentials to the mobile devices in order to use the new types of accounts. The provisioning process may be time consuming, cumbersome, and/or inconvenient for the users, whereby technical solutions are needed.

Uniquely, the systems and methods herein rely on an application identifier, or AID, which is specific to a new type of account, to permit provisioning of credentials associated with the new type of account to a mobile device (in place of credentials for a prior type of account).

In this manner, conversion of the credential in the mobile device may be accomplished, directly by the issuer (e.g., in an automated or automatic manner, etc.), with limited or no involvement of the user of the mobile device, while also enabling checking of the AID to confirm, verify and/or permit the type of the new account. Relatedly, the systems and method herein are permitted to leverage tokens provisioned to the mobile devices as a data connection to enable the conversion described herein (e.g., to enable the checking of the AID, etc.).

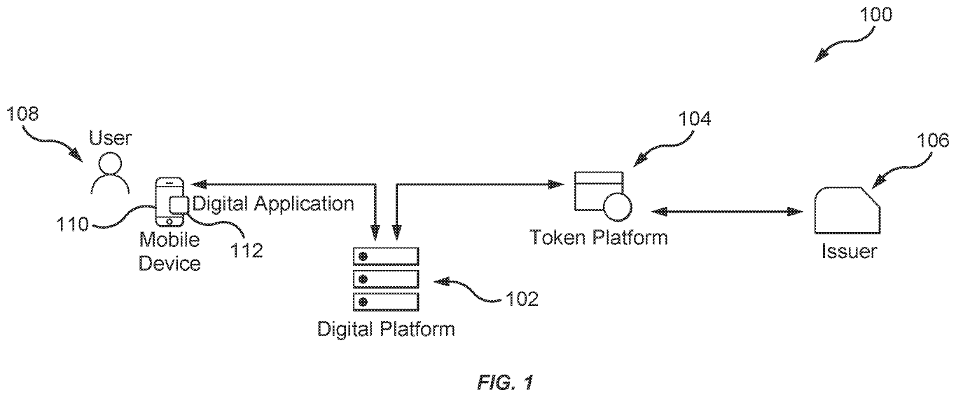

FIG. 1 illustrates an example system 100 in which one or more aspects of the present disclosure may be implemented. Although parts of the system 100 are presented in one arrangement, it should be appreciated that other example embodiments may include the same or different parts arranged otherwise depending on, for example, types of accounts, participants, privacy concerns and/or regulations, etc.

In the illustrated embodiment, the system 100 includes a digital platform 102, a token platform 104, and an issuer 106, each couple in communication through one or more networks. The one or more networks may include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

In this example embodiment, the digital platform 102 includes a digital wallet platform, which cooperates with mobile device 110 (of user 108) to enable payment through the mobile device 110 and other mobile devices. In general, the digital platform 102 is configured to cooperate with the mobile device 110 to provision accounts for use in a “wallet” of the mobile device 110.

In addition, in FIG. 1, the token platform 104 is configured as a tokenization service. As such, the token platform 104 is configured to generate one or more tokens to be used in place of account numbers, for example. One example token platform includes Mastercard Digital Enablement Service (MDES) by MASTERCARD. It should be appreciated that the token platform 104 may be included, in whole or in part, in one or more other platforms, networks, etc. For example, the token platform 104 may be integrated, at least in part, in a payment processing network, such as, for example the MASTERCARD processing network, etc. While illustrated and described herein as separate, it should be appreciated that in some examples the digital platform 102 and the token platform 104 may be combined.

The digital platform 102 and the token platform 104 are configured to cooperate, in general, and as explained herein, to provision tokens to mobile devices to be used thereby, as explained further below.

The issuer 106 generally includes an issuer of accounts. The issuer 106 may include a banking or financial institution, which issues payment accounts, which may be used to fund transactions with different parties for goods, services, etc. In this example embodiment, the issuer 106 is further configured to issue different types of payment accounts. The different types of payment accounts may be understood, for example, to be different brands of payment accounts (or acceptance brands), yet issued or processed through the same processing network, or associated with the same processing network, etc. The types of accounts may further identify broader categories of branded products (e.g., Mastercard, Debit Mastercard, Combo Cards, Flex Cards, Maestro, Cirrus, Private Label, etc.). In this way, example types of payment accounts may include MASTERCARD branded debit accounts, as compared to MAESTRO branded accounts, as further compared to XYZ-other branded accounts, i.e., accounts associated with different brands, etc. Still further, the different types of accounts may include the same brand, but be of a different mode (e.g., credit versus debit versus prepaid, consumer versus commercial, etc.). In general, the different types of accounts each define a different segment of account numbers associated therewith. For example, a segment of a primary account number (PAN), such as the bank identification number (BIN), may be different among different types of accounts. That is, BINs may be separated into segments to permit such differentiation. These segments are often referred to as account ranges.

It should be appreciated that a different “type” of account is different than merely updating an expired account number, expiration date or verification code for the same account, replacing a lost, stolen or damaged card, or graduating the same account to a different status (e.g., elevated from silver to gold, etc.).

In this example embodiment, the issuer 106 has issued a first account to the user 108, where the first account is associated with a first type. As shown in FIG. 1, the user 108 is associated with the mobile device 110. The mobile device 110 may include, without limitation, a smartphone, a tablet, a personal digital assistant (PDA), or other suitable device, etc. In addition, in some examples, the device 110 may include a desktop or laptop computer, an electronic wearable device such as a smart watch or ring, etc. As further shown in FIG. 1, the mobile device 110 includes a digital application 112, which, in this example, includes a wallet application. The digital application 112 is associated with, provided by, published (or developed) by, and/or sponsored by the digital platform 102. The digital platform 102 is configured to communicate with the mobile device 110, via the digital application 112. In turn, the mobile device 110 is configured, by the digital application 112, to store a token specific to a payment account (e.g., the first account of the user 108, etc.) and then to pass the token to a first party (e.g., a merchant, etc.) (not shown) in connection with a transaction.

In particular, in this example embodiment, the mobile device 110 is provisioned with a token associated with the first account of the user 108, which is issued by the issuer 106. The first account, again, is a first type of account, which is associated with a specific application identifier (AID) at the digital platform 102 and/or the token platform 104. In this way, an instance of the digital application 112 is present in the mobile device 110, and configured for the first type of account and the user 108 (e.g., though personalization data, account art, etc.). As such, in response to one or more inputs from the user 108, the mobile device 110 is configured, by the digital application 112, to display the first account to the user 108, accept a selection of the first account for a transaction, and then, to pass the token of the first account, to a merchant, to fund the transaction with the merchant, via the first account. That said, the AID may be associated with (and may be particular to) particular cards which are then associated with particular accounts. In connection therewith, the AIDs may be used, for example, by terminals, etc. during transaction processing to determine available card-specific features, functions, etc. associated with the particular cards and/or the accounts associated therewith

As indicated above, the issuer 106 may offer (or switch to) a second type of account, and the user 108 may decide to adopt (or move to) an account of the second type (or second account) in lieu of the account of the first type (or first account). In connection therewith, it is desired to provision a token consistent with the second account to the mobile device 110. In particular, upon the second account being adopted (in lieu of the first account (e.g., based on one or more rules, inputs, etc.)), for example, by the issuer 106, the issuer 106 is configured to transmit a request to digitize the second account, in place of the first account in the mobile device 110. The request includes an account number (e.g., a funding PAN or FPAN) for both the first account and the second account. The request may be transmitted by the issuer 106 to the token platform 104 through any suitable channel, including, for example, through ABU, PAM API, 0302, R311, CS API, etc. In particular, ABU is an automated Billing Unit Service which may be used by issuers to provide the FPAN update. PAM is a Payment Account Management API that may be used by issuers to provide the FPAN updates. 0302 is an online ISO message channel, where issuers can provide FPAN and Application Transaction Counter updates to a payment network (e.g., the MASTERCARD payment network, etc.). R311 is a bulk file update channel having generally the same format as 0302. CS API is a Customer Service API offered by the token platform 104 to issuers for searching tokens, updating FPAN changes, and updating status of tokens.

It should be understood that the above are provided as example channels, without limitation, and that the request may be communicated through any suitable channel, which may be an API, a payment specific channel (e.g., ISO 8583, ISO 20022, Mastercard BankNet, etc.), a batch file, or another messaging protocol or standard that allows one or more issuers to transmits the request to the token platform 104.

In turn, the token platform 104 is configured to detect the difference in the types of accounts (i.e., first type versus the second type) based on the account numbers, associated BINs or account ranges, or any other attribute either passed to the token platform 104, or previously configured by the issuer 106 on/to the token platform 104.

Specifically, for example, the BIN may be different between the two accounts. After detecting the change in type of account, the token platform 104 is configured to identify the AID (and product name) for the second type of account. In connection therewith, the token platform 104 is configured to search for the second account type, alone or in combination with other data. In one example, a first segment of the account number for the second account is searched along with a country code or product family or category of the second account type. The search may be performed in a data structure, which defines a lookup table for the different AIDs and account types, etc.

When the AID (and product name) is identified, the token platform 104 is configured to transmit a notice to digitize the second account in the mobile device 110 (in place of the first account) to the digital platform 102.

The digital platform 102, in turn, is configured to identify a script, for the digital application 112, to digitize the second account. The script is identified based on the AID and/or the FPAN and/or other components. The digital platform 102 is configured to deliver the script, along with the AID, etc., to the mobile device 110. In this manner, the digital platform 102 is configured to create a security domain and payment applet instance using the AID sent in the request. The mobile device 110 is configured, by execution of the digital application 112 and/or script, to delete the instance (of the digital application 112) for the first account and to create a new instance (of the digital application 112) for the second account. In various embodiments, a related organization may define the standards of how to set up application instances in embedded secure elements in mobile devices (e.g., including in the mobile device 110, etc.). The standards may then be used to securely transfer payment credentials back and forth from the mobile devices to the digital platform 102 and then to the token platform 104. For example, the application instance may be the Mastercard M/Chip Application and may be set up by the digital platform 104, using the above organizational standards. The mobile device 110 is further configured to transmit a request to digitize the new instance of the application 112, with the request including the AID.

In response, the digital platform 102 is configured to pass the request to the token platform 104.

The token platform 104 is configured to verify the AID in the request against the AID for the FPAN of the second account. This may include, for example, verification of the first segment of the AID, which includes a registration identifier (RID) for the product type and/or account type, and a proprietary (PIX) extension of the AID. The verification, in this example, includes matching, but may be otherwise in other embodiments.

If the verification fails, the token platform 104 is configured to halt the conversion and/or provisioning of the second account and to notify the issuer 106 and/or the digital platform 102 of the failure, whereby remediation and/or corrective action may be taken.

Conversely, once verified, the token platform 104 is configured to then generate a token for the FPAN for the second account, and to further define an expiration date, etc., associated with the token, and any other suitable content of the personalization data for the second account and the user 108. Other data may include, for example, public certificates, cryptograms, or other forms of chip and/or EMV data (e.g., consistent with the EMVCO specification/standard, etc.), etc., which may enable one or more operations of the mobile device 110, as configured by the digital application 112. The other data may further include art for the new account (e.g., a front card face, logo, branding, etc.), though the other data may also be provisioned or updated as a separate process after the core payment (e.g., EMV, etc.) data is provisioned.

The token platform 104 is configured to provision the personalization data to the mobile device 110, via the digital platform 102. It should be understood that the personalization data may be provisioned to the mobile device 110 in one or more separate communications. Upon receipt of the personalization data, in whole or in part, the mobile device 110 is configured to update the instance of the application consistent with the personalization data. Once the personalization data is updated to the instance of the application 112, the mobile device 110 is configured, by the digital application, as updated, to display the second account to the user 108, accept a selection of the second account for a transaction, and then, to pass the token specific to the second account (and not the first account) to a merchant, to fund the transaction with the merchant, via the second account.

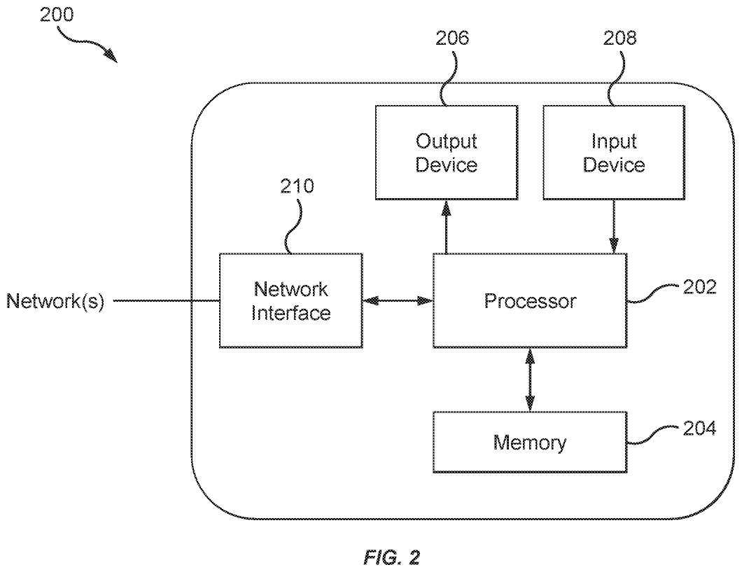

FIG. 2 illustrates the example computing device 200, which may include, for example, one or more servers, workstations, personal computers, laptops, tablets, smartphones, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In at least one embodiment, the computing device 200 is accessed (for use as described herein) as a cloud, fog and/or mist type computing device. With reference to FIG. 1, it should be understood that the digital platform 102, the token platform 104, the issuer 106 and the mobile device 110 may be consistent with, or may include, in whole or in part, the computing device 200. With that said, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permits data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, listings of AIDs per product, personalization data, tokens, account numbers (e.g., FPANs, etc.), and/or other types of data (and/or data structures) suitable for use as described herein. Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 and/or other computer system components configured to perform one or more of the various operations herein, where in performing such instructions the computing device 200 is transformed into a special-purpose computing device. It should be appreciated that the memory 204 may include a variety of different memories, each implemented in one or more of the functions or processes described herein.

In the example embodiment, the computing device 200 also includes an output device 206 that is coupled to (and that is in communication with) the processor 202. The output device 206 outputs information, such as options to select accounts and/or account types, etc., visually, for example, to the user 108 via one or more interfaces of the digital application 112, or other information associated with the parties illustrated in FIG. 1, at a respective computing device, etc. The output device 206 may include, without limitation, a liquid crystal display (LCD), a light-emitting diode (LED) display, an organic LED (OLED) display, an “electronic ink” display, speakers, etc. In some embodiments, the output device 206 may include multiple devices.

In addition, the computing device 200 includes an input device 208 that receives inputs from the user 108 (i.e., user inputs) such as, for example, selections of accounts, requests to adopt new accounts, etc., from the user 108 or other information from users in the system, etc. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both the output device 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks and/or one or more other computing devices herein. One example wireless network includes near-field communication (NFC) connection between the mobile device 110 and a computing device of a merchant (e.g., POS terminal, etc.). Other similar wireless network connections may include BLUETOOTH connection, etc.

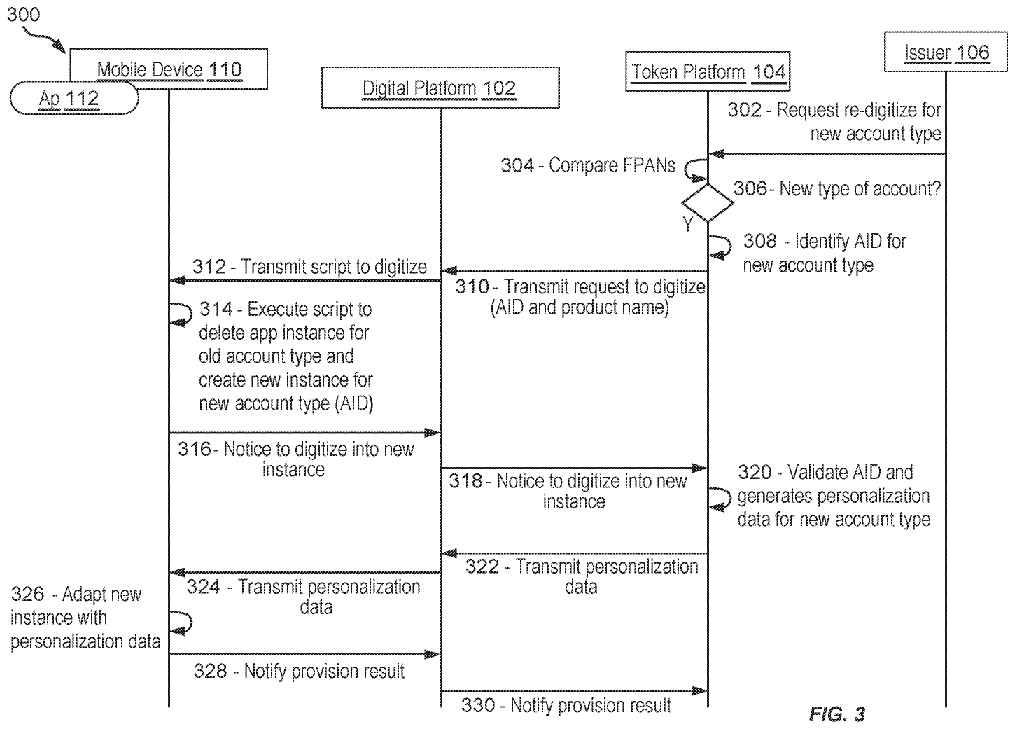

FIG. 3 illustrates an example method 300 for account credential conversion based on a new account type. The example method 300 is described (with reference to FIG. 1) as generally implemented in the system 100, and with further reference to the computing device 200. As should be appreciated, however, the methods herein should not be understood to be limited to the example system 100 or the example computing device 200, and the systems and the computing devices herein should not be understood to be limited to the example method 300.

At the outset, it is assumed that the digital application 112 is installed and active in the mobile device 110, and also that tokenization data for a first payment account of a first type (e.g., a MAESTRO credit account, etc.) is provisioned to the digital application 112 and/or mobile device 110. In this manner, the mobile device 110 is usable as a “payment device” to fund transactions through the MAESRTO account. The first account is linked to a specific FPAN (e.g., first FPAN, etc.), and also a token provisioned to the digital application 112.

In connection with the above, the issuer 106 may offer a payment account of an alternate type (e.g., a DEBIT MASTERCARD account, etc.). The issuer 106 may then decide to adopt it in lieu of the first payment account. It should be appreciated that the issuer 106 may adopt the alternative type account, in lieu of the first account (e.g., based on obsolescence, restrictions, etc.), whereby the first type of account is no longer supported by the issuer 108 (such that the user is required to adopt the alternative type of account), or potentially based on an input and/or request from the user 108. The alternate type of account, or second account, may then optionally be (where the timing may be different in other embodiments) issued to the user 108 by the issuer 106 (e.g., pursuant to one or more procedures, or based on the existence of the first account, etc.). In connection therewith, the issuer 106 assigns a second FPAN to the second account and then requests the second account to be digitized in the mobile device 110, in place of the first account.

In doing so, at 302, the issuer 106 transmits the request, which includes the first FPAN and the second FPAN, to the token platform 104. It should be appreciated that other data, such as, for example, country code, currency code, product family/category, new type indicator/identifier, etc., may be provided with, or in place of, one or more of the FPANs.

The token platform 104 compares, at 304, the first and second FPANs (or other received information) and, based on the comparison, determines, at 306, in this example, whether the account is a new type of account, or not. Specifically, a part of the FPAN is linked to a specific type of account (e.g., the BIN, the BIN+X digitals, or account range of the FPAN, etc.). The token platform 104 is thus able to identify a difference in that part of the FPANs, between the FPANs, and based thereon, determine the second FPAN is for a new type of account (or different type associated with the prior (or first) FPAN). It should be appreciated that the new type of account may be determined otherwise based on the FPANs or other data from the issuer 106 and related to the accounts (e.g., product names, type indicators/identifiers apart from the FPAN, descriptions, etc.), etc.

In addition to type, the token platform 104 may optionally impose one or more additional rules to permit, or not permit, the conversion of the credential in the mobile device 110. For example, the token platform 104 may confirm one or more of: the issuers of the first and second account are the same; one or both of the FPAN are within a specific range (e.g., which is indicative of the accounts being enabled for tokenization, or enabled for wallet provisioning, etc.); and/or the digital platform 102 and/or the application 112 is configured for, or permitted to, accept credential conversion as described herein; etc. It should be appreciated that the token platform 104 (or the digital platform 102, or the issuer 106) may enforce additional, different or related rules to ensure proper permissions, privacy and enablement of the conversion described herein.

That said, after the token platform 104 determines the account type is new (and optionally, applies desired rule(s)), the token platform 104 identifies, at 308, an AID for the new account type of the second account. The AID may be identified from a data structure, such as shown in Table 1 below, which includes each AID for each part of the FPAN, where each FPAN is issued by the same issuer, i.e., issuer 106 herein. As such, in this example, the token platform 104 searches in the data structure for the AID based on the relevant received data (e.g., FPAN, country code, etc.).

TABLE 1

| AID | FPAN | Country Code | Product Name |
|---|---|---|---|
| A0000000043060 | *12345678* | ANY | MSI (Maestro) |
| A0000000043060 | *22345678* | Brazil | MSI (Maestro) |
| A0000007800004 | *32345678* | USA | PVL (Private Label) |
| A0000000049100 | *42345678* | USA | PVL (Private Label) |
| A0000000041010 | *52345678* | ANY | DMC (Debit Mastercard) |
| A0000000041010D07612 | *62345678* | Brazil | DMC (Debit Mastercard) |
| A0000000041010 | *72345678* | ANY | MCC (Mastercard Credit) |
| A0000000041010 | *82345678* | ANY | MCC (Mastercard Credit) |

It should be appreciated that more or less data may be included in the data structure, and further, for the basis for identifying the AID for the account type.

When the AID for the second account is identified, the token platform 104 transmits a request, at 310, to the digital platform 102 to digitize the second account to the mobile device 110, in place of the first account (as existing in the mobile device 110). Importantly, the request includes the AID and the product name for the second account. In turn, the digital platform 102 identifies (based on the AID and/or FPAN) and transmits, at 312, a script consistent with the request and which includes the AID. By including the AID in the request, any changes in the AID may be account for in the subsequent processes of the method 300 (as opposed to previous approaches in which the AID was assumed not to change, etc.).

Upon receipt of the script, the mobile device 110 executes, at 314, the script, which causes the existing instance of the application 112 to be deleted and a new instance of the application 112 to be created. The new instance of the application 112 is specific to the AID identified at 308 for the new account type, and received from the digital platform 102. At 316, the mobile device 110 transmits a notice to the digital platform 102 to digitize the second account into the mobile device 110 to the new instance (of the application 112), and at 318, the digital platform 102 transmits a notice to the token platform 104 to digitize the second account into the mobile device 110 to the new instance (of the application 112). The digital platform 102 may merely forward the notice from the mobile device 110, or modify as necessary. The notice includes one or more of the FPAN for the second account, the product name, country code, etc., and also the AID for the new instance, etc.

In response, at 320, the token platform 104 verifies (or validates) the AID and, when verified, generates personalization data for the new instance. Specifically, the AID is verified based on the second account, i.e., new type of account as indicated by the FPAN and/or product name, to identify an AID (e.g., from Table 1) and to compare the AID to the AID received from the digital platform 102. It should be appreciated that this verification is not performed in conventional methods, whereby issues or failures that may arise (unexpectedly) in such conventional methods in connection with the provisioning, as described below, are accommodated and/or account for by the method 300. In generating the personalization data, the token platform 104 generates a new token for the second account, alone with other associated data (e.g., expiration date, verification code, certificates, cryptograms, etc.). The generated data is compiled into the personalization data. In addition, card art, logos, and other details of the second account may be included in the personalization data, or may be requested after the provisioning of the personalization data is completed.

If the verification fails (at 320), the token platform 104 is configured to halt the conversion and/or provisioning of the second account and to notify the issuer 106 and/or the digital platform 102 of the failure, whereby remediation and/or corrective action may be taken.

It should be appreciated that while the token for the second account, alone with the expiration date, is different (than for the first account), a token unique reference and an FPAN unique reference may be preserved or remain the same between the token platform 104 (and the digital platform 102 and the mobile device 110). The token unique reference is the unique identity of the token PAN present on the device 110 and assigned to the digital wallet. As such, even if the token PAN changes, like in the implementation described herein, the token unique reference remains the same. The FPAN unique reference is the unique value mapped to the FPAN. The FPAN unique reference is unchanged from mobile device to mobile device for same FPAN.

At 322, in response to verification/validation of the AID and generation of the personalization data, the token platform 104 transmits the personalization data, in an instruction to provision the second account to mobile device 110, to the digital platform 102. The digital platform 102, in turn, at 324, transmits the personalization data to the mobile device 110.

The mobile device 110 then adapts, at 326, the new instance of the application 112 consistent with the personalization data, whereby the second account is provisioned to the application 112 of the mobile device 110. At 328, the mobile device 110 notifies the digital platform 102 of the provision result, for example, that the second account provision is successful, or not. The digital platform 102, in turn, at 330, notifies the token platform 104 of the provision result.

While the personalization data is transmitted to the digital platform 102 and the mobile device 110 as a single communication, it should be appreciated that the personalization data may be separated into multiple segments, with each segment being transmitted separately. For example, the user-specific personalization data may be transmitted in a first provisioning instruction, and then, second account specific data (e.g., card art, etc.) may be transmitted in a second provisioning instruction.

In view of the above, the systems and methods herein provide for a seamless experience to (e.g., automatically without action by the user, etc.) replace existing tokenized accounts with new types of accounts. Conventionally, the digital platform and the token platform have not supported converting one account type to another account type, without user participation, which creates friction. Uniquely, here, in response to a request from the issuer of the new type of account, any token PAN for a Product Type A account in the wallet application of the user's mobile device may be replaced or converted (substantially automatically or in an automated manner) to a token PAN for a Product Type B account by leveraging an AID specific to the Product Type B. The friction of involving the user to replace/convert an outdated, obsolete, or not preferred account type is therefore limited, or eliminated by the present disclosure.

Again, and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a request to digitize a second account in a mobile device, in place of a first account; (b) determining a type of the second account is different than a type of the first account; (c) identifying a first application identifier (AID) for the second account and transmitting, to a digital platform computing device, a request to digitize the second account to the mobile device; (d) receiving, from the digital platform computing device, a notice to digitize the second account to an instance of the application for the second account in the mobile device, where the notice includes an AID for the first account; (e) validating the AID for the first account; and (f) generating and transmitting personalization data to the digital platform computing device.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in converting account credentials in mobile devices, the system comprising:
a token platform computing device, which is configured, by executable instructions, to:
receive, from an issuer of a second account, a request to digitize the second account in an application of a mobile device, in place of a first account, the request including a first funding primary account number (FPAN) associated with the first account and a second FPAN specific to the second account;
determine that a type of the second account is different than a type of the first account;
based on determining the type of the second account is different:
identify an application identifier (AID) for the second account; and
transmit, to a digital platform computing device, a request to digitize the second account to the mobile device;
receive, from the digital platform computing device, a notice to digitize the second account to an instance of the application for the second account in the mobile device, the notice including an AID for the first account;
validate the AID for the first account based on the AID for the second account and/or the type of the second account; and
based on the AID for the first account being validated, generate and transmit personalization data for the instance of the application in the mobile device, to the digital platform computing device.

2. The system of claim 1, wherein the token platform computing device is configured to compare the first FPAN and the second FPAN, in order to determine that the type of the second account is different than the type of the first account.

3. The system of claim 1, wherein the request includes other data specific to the second account, the other data including a country code and/or a product name; and
wherein the token platform computing device is configured to identify the AID for the second account further based on the other data.

4. The system of claim 1, wherein the token platform computing device is configured, in order to identify the AID for the second account, to search for at least a part of the second FPAN in a data structure.

5. The system of claim 1, further comprising the digital platform computing device, which is configured, by other executable instructions to:
receive the request to digitize the second account; and
in response to the request to digitize the second account:
identify a script based on the AID for the second account and/or the second FPAN, wherein the scrip configures the mobile device to delete an instance of the application associated with the first account and to create the instance of the application for the second account in the mobile device; and
transmit the script to the mobile device.

6. The system of claim 1, wherein the personalization data includes a token specific to the second account; and/or
wherein the personalization data includes an expiration date for the token and a verification code for the token.

7. The system of claim 1, wherein the personalization data includes card art specific to the type of the second account.

8. The system of claim 1, wherein the type of the second account is different than the type of the first account based on brand and/or processing network; and
wherein the first account is issued by said issuer.

9. The system of claim 1, wherein the token platform computing device is configured, in order to validate the AID for the first account, to search for at least a part of the second FPAN in a data structure and compare an AID from the search to the AID for the first account received from the digital platform computing device.

10. A non-transitory computer-readable storage medium comprising executable instructions, which when executed by at least one processor of a token platform computing device, cause the at least one processor to:
receive, from an issuer of a second account, a request to digitize the second account in an application of a mobile device, in place of a first account, the request including a first funding primary account number (FPAN) associated with the first account and a second FPAN specific to the second account;
determine that a type of the second account is different than a type of the first account;
based on determining the type of the second account is different, identify an application identifier (AID) for the second account and transmit, to a digital platform computing device, a request to digitize the second account to the mobile device;
receive, from the digital platform computing device, a notice to digitize the second account to an instance of the application for the second account in the mobile device, the notice including an AID for the first account;
validate the AID for the first account based on the AID for the second account and/or the type of the second account; and
based on the AID for the first account being validated, generate and transmit personalization data for the instance of the application in the mobile device, to the digital platform computing device.

11. The non-transitory computer-readable storage medium of claim 10, wherein the executable instructions, when executed by the at least one processor of the token platform computing device, cause the at least one processor to compare the first FPAN and the second FPAN, in order to determine that the type of the second account is different than the type of the first account.

12. The non-transitory computer-readable storage medium of claim 10, wherein the request includes other data specific to the second account, the other data including a country code and/or a product name; and
wherein the executable instructions, when executed by the at least one processor of the token platform computing device, further cause the at least one processor to identify the AID for the second account further based on the other data.

13. The non-transitory computer-readable storage medium of claim 10, wherein the executable instructions, when executed by the at least one processor of the token platform computing device, cause the at least one processor, in order to identify the AID for the second account, to search for at least a part of the second FPAN in a data structure.

14. The non-transitory computer-readable storage medium of claim 10, wherein the personalization data includes an expiration date for the token and a verification code for the token.

15. The non-transitory computer-readable storage medium of claim 10, wherein the personalization data includes a token specific to the second account.

16. The non-transitory computer-readable storage medium of claim 10, wherein the personalization data includes card art specific to the type of the second account.

17. The non-transitory computer-readable storage medium of claim 10, wherein the type of the second account is different than the type of the first account based on brand and/or processing network; and/or
wherein the first account is issued by said issuer.

18. The non-transitory computer-readable storage medium of claim 10, wherein the executable instructions, when executed by the at least one processor of the token platform computing device, cause the at least one processor, in order to validate the AID for the first account, to search for at least a part of the second FPAN in a data structure and compare an AID from the search to the AID for the first account received from the digital platform computing device.

19. A computer-implemented method for use in converting account credentials in mobile devices, the method comprising:
receiving, by a computing device, from an issuer of a second account, a request to digitize a second account in an application of a mobile device, in place of a first account, the request including a first funding primary account number (FPAN) associated with the first account and a second FPAN specific to the second account;
determining, by the computing device, that a type of the second account is different than a type of the first account;
based on determining the type of the second account is different:
identifying an application identifier (AID) for the second account; and
transmitting, to a digital platform computing device, a request to digitize the second account to the mobile device; and
receiving, by the computing device, from the digital platform computing device, a notice to digitize the second account to an instance of the application for the second account in the mobile device, the notice including an AID for the first account;
validating, by the computing device, the AID for the first account based on the AID for the second account and/or the type of the second account; and
based on the AID for the first account being validated, generating and transmitting, by the computing device, personalization data for the instance of the application in the mobile device, to the digital platform computing device.

20. The computer-implemented method of claim 19, wherein the request includes other data specific to the second account, the other data including a country code and/or a product name; and
wherein identifying the AID for the second account is further based on the other data.
